(19) United States
(12) Patent Application Publication
(10) Pub. No.: US 2022/0346332 A1
(43) Pub. Date: Nov. 3, 2022

(54) ROOT GROWTH PLATFORM AND METHODS THEREOF

(71) Applicant: PIONEER HI-BRED INTERNATIONAL, INC., JOHNSTON, IA (US)

(72) Inventors: RANDY TODD CLARK, ANKENY, IA (US); CHRISTINE HELEN DIEPENBROCK, DAVIS, CA (US); CARLOS MESSINA, GAINESVILLE, FL (US); LEANDRO DANIEL PERUGINI, URBANDALE, IA (US)

(73) Assignee: PIONEER HI-BRED INTERNATIONAL, INC., JOHNSTON, IA (US)

(21) Appl. No.: 17/754,034

(22) PCT Filed: Sep. 24, 2020
(86) PCT No.: PCT/US20/52489

§ 371 Date: Mar. 22, 2022

Related U.S. Application Data
(60) Provisional application No. 62/907,159, filed on Sep. 27, 2019.

(51) Int. Cl. A01G 31/02

(52) U.S. Cl. CPC A01G 31/02

(57) ABSTRACT

Methods to analyze performance of plants, performance of roots to varying temperatures and yield potential are provided. Genetic variations that contribute or impact root growth, root development are evaluated to enable breeding of plants with improved root response to temperatures. Crop growth models supplemented with root function modeling provide better predictive power of yield and/or yield-related traits.

### FIELD

The field relates to plant molecular genetics and breeding with regards to the use of root response to soil temperature variations.

### BACKGROUND

Root systems underpin a plant's ability mine the soil for essential nutrients and water resources and thrive in their environment. Yield loss due to abiotic stress, for example due to reduced water availability or nutrient availability results in a great loss of agricultural production. Soil temperatures vary in climatic zones and depending on a weather event, for example, a cold spell in northern latitudes, the soil temperatures can fall rapidly. Yield predictions and methods to improve yield based on a plant's root growth response are desirable to increase agricultural output in a sustainable fashion for generations to come. Temperature gradients within the soil profile vary seasonally and by geographic location. Root growth responses to root zone temperature vary both within and across crop species and is negatively impacted when the soil temperatures decrease.

Improved crop growth and increased yield performance, while retaining the ability to resist and avoid water stress, maximize root exploration and nutrient capture through sustained root growth and vigor under sub-optimal root zone and soil temperatures through conventional breeding, transgenic or gene-edited approaches are desired.

### SUMMARY

Enhancement of crop growth, yield performance, and the ability to resist and avoid water stress by specifically targeting sustained root growth and vigor under sub-optimal root zone and soil temperatures through conventional breeding, transgenic or genome edited approaches are provided herein and further includes systems and platforms for delivering improved crop performance in a sustainable manner. In as aspect, the disclosure encompasses an end-to-end methodology to screen and identify resistant germplasm or any genetic determinant, identify genomic regions and gene targets for introgression, targeted genome editing within native germplasm or across species, introduce genetic modifications through genome editing, breeding, traditional mutagenesis methods, assess efficacy of introduced root growth enhancements within developed plant material, and quantifiably evaluate the impacts of introduced enhancements to water relations and yield performance in multiple crops species, including maize, rice, sorghum, soybean, cotton, canola and other crops.

In an aspect, a method to increase yield of plants grown under one or more environmental conditions, the method includes growing a plant in a field condition, wherein the plant has been selected for increased yield potential based on a crop growth model (CGM) that includes one or more parameters of a root growth model (RGM), wherein the root growth model comprises phenotypic or genotypic association data with respect to the growth and/or root development of roots in response to temperature variation.

A dual hydroponic-aeroponic root growth platform (RGP) system to evaluate a root system architecture (RSA), includes: a three-dimensional scaffold contained within a temperature controlled root growth chamber, wherein the scaffold enables the growth of the roots such that the RSA is facilitated, whereby one or more architectural and growth characteristics of the root are capable of being measured over time; and the controlled chamber comprises a variable hydroponic-aeroponic system to evaluate root and root system functional responses to root zone temperature, wherein temperature controlled nutrient solution is provided both hydroponically and aeroponically to simulate temperature gradient profiles in a field soil system. In an embodiment, the scaffold comprises a plurality of mesh septum/septa that comprises pores to enable growth of roots in a three-dimensional architecture.

In an aspect, the root growth and/or root development is controlled by one or more quantitative trait loci (QTL). In an aspect, the RGM comprises marker data that correlate with the performance of plant roots under varying temperatures. In an aspect, the plant comprises a native genetic variation, an introduced genetic modification, a transgenic trait, or a combination thereof, that impact root growth in response to temperature. In an aspect, the plant is selected by whole genome prediction for improved performance of plants due to improved root growth at cooler soil temperatures compared to control plants. In an aspect, the plants are planted early in the field compared to control plants that are not selected for increased yield potential. In an aspect, the plants are planted at a planting density that is at least 10% to about 30% higher compared to control plants. In an aspect, the plants are drought tolerant. In an aspect, the plants are cold tolerant.

In an aspect, a method of obtaining a population of plants for increased yield potential, the method includes breeding a population of plants, wherein one or more members of the population of the plants have been screened for performance of improved root growth under colder soil temperatures in a range of about 5° C. to about 20° C.; performing a genotypic analysis, a phenotypic analysis, or a combination thereof, for improved performance of root growth, root development, or a combination thereof, on at least a subset of the population of the plants; and obtaining the population of plants with increased yield potential based on the genotypic and/or phenotypic analysis of at least the sub-population of the plants.

In an aspect, the genotypic analysis for root growth/performance is based on a whole genome prediction method.

In an aspect, a method of analyzing genotypic variation in a population of plants for the performance of root growth and/or development in response to varying temperatures, the method includes obtaining the population of plants comprising varying levels of a root growth trait; growing the plants under a range of temperatures, wherein the root temperatures are maintained in a range of about 2.5° C. (2.5 degree Celsius) to about 20° C. for at least 2 days; selecting the plants that exhibit one or more improved agronomic characteristics; and performing genotypic analysis on the selected plants, thereby obtaining genotypic variation data for a root growth model and/or or a crop growth model. In an aspect, the genotypic analysis is performed with a plurality of markers representing a portion of the genome.

Suitable temperatures for maintaining the root growth chamber, growth tank, root pressure chamber, or other root growing container disclosed herein include for example, about 2, 2.5, 3, 3.5, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, and 35 degree Celsius.

In an aspect, a method of improving nutrient capture and utilization efficiency for a particular population of plants based on response of plant roots to temperature, the method includes growing a population of plants in a field condition, wherein the field contains at least a portion of nutrient requirement, the nutrient application to the soil was selected based on a root growth model (RGM) for the population of plants, the RGM included genotypic and/or phenotypic data for the population of plants and the response of their roots to varying soil temperatures; optionally, provide an in-season application of nutrients based on a crop growth model (CGM) for the performance of the plants, wherein the in-season application is specifically chosen for the population of plants, thereby improving nutrient utilization efficiency of the plants.

In an aspect, a method of predicting yield of a population of plants, the method includes building a crop growth model (CGM) that includes one or more factors accounting for root growth and/or root development in response to varying soil temperatures under one or more crop growing environments; growing the population of the plants in a field having the one or more crop growing environments; obtaining soil temperature data or predicted soil temperature data for the field; and predicting yield for the population of plants based on a plurality of factors including performance of the population of plants that depends on the ability of the roots of the plants to grow and/or develop at varying soil temperatures.

In an aspect, a method of high-throughput analysis of response of roots of a population of plants to root temperature variation, the method includes providing an aeroponic-hyrdoponic root growth platform (RGP) to evaluate a root system architecture (RSA) and growth response to root zone temperatures, wherein the hydroponic-aeroponic platform (i) includes a scaffold to preserve the RSA and (ii) facilitate quantification of root growth and one or more architectural characteristics in a three-dimensional set-up over time; providing a root pressure chamber system to evaluate root and root system functional responses to root zone temperature, wherein the root pressure chamber system includes (i) temperature control (ii) root zone pressure control (iii) a stem and/or stalk sealing mechanism (iv) gas exchange monitoring; growing a population of plants in the RGP, wherein the plants exhibit varied root growth characteristics to root zone temperature variation and wherein the RGP maintains a root temperature of about 5° C. to about 30° C.; quantifying the root growth and response to temperatures of the plants growing in the RGP by automated acquisition and processing images to quantitate the root growth and/or root development; and analyzing the response of the roots of the population of plants. In an aspect, the population of plants are maize. In an aspect, the population of plants are screened for (a) native variation, (b) introduced targeted genetic modification, (c) transgenic variation, (d) non-targeted introduced genetic modification or (e) a combination thereof. In an aspect, the images are obtained using one or more of the following: an optical digital camera, hyperspectral image acquisition device, an X-ray image acquisition device or an infra-red camera In an aspect, the RGP comprises variations in nutrient availability.

In an aspect, a method of providing a crop management solution to a population of plants growing in a field, the method comprising measuring or otherwise obtaining soil temperature of the field including using historical soil temperature information for the field; providing root performance of the plants growing in the field at one or more soil temperatures; incorporating the root performance data into a computer implemented program to model prediction of yield; and providing nutrient and/or fertilizer recommendation to the field In an aspect, the population of plants is maize. In an aspect, the nutrient and/or fertilizer recommendation comprises pre- and in-season recommendation. In an aspect, the substantial population of the plants were selected to comprise one or more genetic variations that affect root performance to varying soil temperatures. In an aspect, the crop management solution is based on a crop growth model that specifically includes a root function model. In an aspect, the fertilizer recommendation is based on the ability the roots of the population of plants to capture nitrogen at a certain depth based on the modeling of the performance of the roots at a particular range of soil temperature.

In an aspect, a soil-based root growth evaluation system includes a three-dimensional soil chamber, wherein the soil chamber comprises a plurality of heating-cooling elements such that the soil maintains a gradient of temperature profile, the temperature profile ranges from a higher temperature at the top level to a colder temperature at a lower level, wherein the root growth evaluation system is portable, high-throughput and capable of image acquisition by an image sensor at one more or more time interval to measure the root growth at varying temperatures. In an aspect, the evaluation is performed with a population that comprises genetically distinct inbred lines. In an aspect, the evaluation is performed with a population that comprises genome edited or transgenic plant varieties. In an aspect, the heating-cooling elements comprise one or more thermocouples capable of heating or cooling the soil subsections from about 2.5 degree Celsius to about 35 degree Celsius.

In an aspect, a temperature controlled root pressure chamber system comprising a component selected from the group consisting of a temperature control, a root zone pressure control, a stem and/or stalk sealing structure configured to permit a plant comprising variable stalk diameter, and gas exchange monitoring system, wherein the root pressure chamber maintains a temperature between about 2.5° C. to about 30° C.

In an aspect, the root pressure chamber system is configured to evaluate plant material from soil-less, soil-like and soil media growth within net pots, tubes, tube suspended seedlings, or other containers. In an aspect, the conductance of the plant is capable of being measured at various pressures, for example up to and about 1.5 MPa, 1.6 MPa, 1.7 MPa, 1.8 MPa, 1.9 MPa, 2.0 MPa, 2.1 MPa, 2.2 MPa, 2.3 MPa, 2.4 MPa and 2.5M Pa.

In an aspect, a multiplex hydroponic root growth platform (RGP) system to evaluate a root system architecture (RSA), includes a temperature controlled root growth chamber comprising a liquid nutrient media, wherein the liquid media is maintained at a pre-determined temperature; a plurality of individual plants housed within separate divided enclosures such that their roots are capable of growing and maintaining the root system architecture over time; and a plurality of temperature controlled root growth chambers, wherein the temperature of one or more of the individual growth chambers are maintained at a specific pre-determined temperature within 2.5° C. to about 30° C. In an aspect, the temperature controlled root growth chamber is insulated and the top of the chamber is sealed and is configured to receive a plurality of plants such that the plants are separably positioned through a plurality of openings. In an aspect, the divided enclosures are made up of a material that is suitable for high throughput imaging to measure one or more of the root characteristics at the predetermined temperatures In an aspect, the system includes an image acquisition device to obtain one or more images of the growth of the roots within the enclosures over time, thereby quantifying the root growth and/or root development. In an aspect, the colder nutrient solution is provided hydroponically through the lower (bottom) portion of the chamber and warmer nutrient solution is provided aeroponically through the upper (top) portion of the chamber. In an aspect, the plurality of the plants are maize.

### BRIEF DESCRIPTION OF THE DRAWINGS

FIG. 1 shows (A) insulated root growth chambers with one plant per chamber (B) multiple plants per chamber, (C) top cover removed showing the growth of the plant, (D) 3-D view of the root growth chamber showing the horizontal septum and (E) shows root growth for multiple plants inside the chamber.

FIG. 2 shows the temperature controlled root pressure chamber system with corn plants at V6 growth stage.

FIG. 3 shows a schematic of the root growth platform assembly with multiple root growth tanks within four tanksets, a PLC controller and a supply tank.

FIG. 4 shows the assembly containing pumps, flow control valves, chiller and heater for supplying temperature controlled nutrient solutions to the growth tanks.

FIG. 5 shows the side view (left) and the top view (right) of cross sectional schematic of the growth tanks where the misting heads and bulkheads are positioned.

FIG. 6 shows the various inputs, outputs, and functional attributes of a crop growth model (CGM) that takes into account root system modeling (RSM) and root front modeling (RFM).

FIG. 7 shows the difference in crop growth model based root development prediction with root function (indicated by an arrow) and without inclusion of the root function (indicated by a dot) at various latitudinally distributed experimental locations within North America. Root depth at emergence; maximum rooting depth in some locations is less than 1800 mm.

FIG. 8 shows a digital image of the root system grown in the root growth chamber.

FIG. 9A shows the components of a root pressure chamber comprising chamber cap, sealing harness, sealing gasket, pressure chamber and reinforcement shims.

FIG. 9B shows a corn plant growing within the root pressure chamber system.

### DETAILED DESCRIPTION

The current disclosure provides methods for increasing yield and/or improved performance and nutrient capture under drought stress and/or non-limited management practices.

Identification and selection of beneficial root system traits in complex production environments (e.g., maize hybrids) is often impacted by trait by environment interaction. Further, evaluation of root system traits to performance outcomes is also impacted by constraints of phenotyping roots at scale and depth in field environments. This evaluation is desirable, for example for evaluating, the root systems of modern maize hybrids, which have been shaped through recurrent selection for yield, yield stability and agronomic performance in high plant populations under agricultural intensification. Root system responses to temperatures and their growth and functional responses to low temperatures offer the potential to be leveraged for improving water stress resistance, nutrient capture and yield performance.

In various illustrated embodiments, high throughput phenotyping systems were developed to further investigate root system growth and functional responses to root zone temperature and examine genetic variability for these low temperature responses across diverse germplasm. In additional embodiments, simulations tools were developed and deployed to evaluate the impacts that low temperature response traits have on overall yield performance in background of known shoot traits of modern commercial hybrids. Improvements to low temperature responses were found to increase yields and when modeled together with observed variation for shoot traits, where those improvements explained more yield variation than any single shoot trait on a large segment of the agricultural acres in the United States. These results further support the utility of low temperature responses and enable root biology and crop improvement initiatives that can be applied to benefit the soil water and nutrient capture and yield performance of crops over a wide range of agricultural production environments.

A root growth model that takes into account one or more physiological aspects of plant growth, development and function that underpin G×E×M outcomes in complex environments is desirable. For example, root systems provide a broad mechanism for tuning the water and nutrient capture relationships of crop plants through their development, function, morphology, architecture and interaction with the soil environment and microbiome. In an embodiment, such a model would also provide a framework for evaluating abiotic and biotic factors that limit the root systems' ability to grow and capture soil resources and prevent a crop from reaching full productivity. In the absence of an evaluation system like the one described herein, direct selection for root system ideotypes and individual root traits can be limited by one or more trade-offs when placed in the broader context of complex and varying agricultural production environments. For example, germplasm selection that is focused on chilling stress resilience during seed germination and emergence to ensure stand establishment in cold (such as wet topsoil conditions and fluctuating springtime weather patterns), alone in the absence of additional parameters, would not account for example, cold temperature isotherms that persist within the soil profile throughout the growing season. Root growth model described herein take into account such temperature isotherms that are established and move through the profile based on daily and seasonal weather cycles and underling soil texture, management and compositional properties.

In certain embodiments, the root growth model takes into account and model the behavior of roots, as they grow through the soil profile from warmer to cooler temperature isotherms and push up against low temperature barriers that limit their growth, soil exploration and function.

In certain embodiments, the root growth model takes into account and model the behavior of roots, when the root system is exposed to sub-optimal temperatures that have been found to reduce the elongation and branching embryonic roots, change the initiation angle and gravitropic responses of root meristems, impair aquaporin function, reduce water and nutrient transport to the growing shoot, decrease root system respiration and dynamically alter the carbohydrate sink localization within the root system.

In certain embodiments, the root growth model takes into account and model root growth at low temperature isotherms that influence the extent to which root systems can explore and mine the soil profile, which have indirect effects on the resource dynamics of the entire plant throughout the growing season. To further characterize low temperature effects on the root system growth and function, phenotyping platforms were developed and studies were conducted to examine root systems responses to colder root zone temperatures. Genetic mapping studies were then performed to investigate breeding opportunities within maize germplasm and simulation tools were developed to further test the hypothesis and assess the potential opportunities cold temperature responses have across agricultural environments of the US. Various genetic modifications introduced through breeding were evaluated as part of the root growth platform.

In an embodiment, the disclosure relates to the enhancement of crop growth, yield performance, and the ability to resist and avoid water stress by specifically targeting sustained root growth, function, and vigor under sub-optimal root zone and soil temperatures through conventional breeding, transgenic or gene-edited approaches combined with developed methodology and platforms.

In an embodiment, the disclosure encompasses an end-to-end methodology to screen and identify resistant germplasm, identify genomic regions and gene targets for introgression or editing within native germplasm or across species, assess efficacy of introduced root growth enhancements within developed plant material, and quantifiably evaluate the impacts of introduced enhancements to water relations and yield performance in multiple crops species.

In an embodiment, the disclosure relates to the enhancement of crop growth, yield performance, and the ability to enhance soil exploration and nutrient capture by specifically targeting sustained root growth and vigor under sub-optimal root zone and soil temperatures through conventional breeding, transgenic or gene-edited approaches combined with developed methodology and platforms.

The disclosure of each reference set forth herein is hereby incorporated by reference in its entirety.

As used herein and in the appended claims, the singular forms “a”, “an”, and “the” include plural reference unless the context clearly dictates otherwise. Thus, for example, reference to “a plant” includes a plurality of such plants, reference to “a cell” includes one or more cells and equivalents thereof known to those skilled in the art, and so forth.

As used herein, the term “allele” refers to a variant or an alternative sequence form at a genetic locus. In diploids, single alleles are inherited by a progeny individual separately from each parent at each locus. The two alleles of a given locus present in a diploid organism occupy corresponding places on a pair of homologous chromosomes, although one of ordinary skill in the art understands that the alleles in any particular individual do not necessarily represent all of the alleles that are present in the species.

As used herein, the phrase “associated with” refers to a recognizable and/or assayable relationship between two entities. For example, the phrase “associated with a trait” refers to a locus, gene, allele, marker, phenotype, etc., or the expression thereof, the presence or absence of which can influence an extent, degree, and/or rate at which the trait is expressed in an individual or a plurality of individuals.

As used herein, the term “backcross”, and grammatical variants thereof, refers to a process in which a breeder crosses a progeny individual back to one of its parents: for example, a first generation F₁ with one of the parental genotypes of the F₁ individual.

As used herein, the phrase “breeding population” refers to a collection of individuals from which potential breeding individuals and pairs are selected. A breeding population can be a segregating population.

A “candidate set” is a set of individuals that are genotyped at marker loci used for genomic prediction. The candidates may be hybrids.

As used herein, the term “chromosome” is used in its art-recognized meaning as a self-replicating genetic structure containing genomic DNA and bearing in its nucleotide sequence a linear array of genes.

As used herein, the terms “cultivar” and “variety” refer to a group of similar plants that by structural and/or genetic features and/or performance can be distinguished from other members of the same species.

As used herein, the phrase “determining the genotype” or “analyzing genotypic variation” or “genotypic analysis” of an individual refers to determining at least a portion of the genetic makeup of an individual and particularly can refer to determining genetic variability in an individual that can be used as an indicator or predictor of a corresponding phenotype. Determining a genotype can comprise determining one or more haplotypes or determining one or more polymorphisms exhibiting linkage disequilibrium to at least one polymorphism or haplotype having genotypic value. Determining the genotype of an individual can also comprise identifying at least one polymorphism of at least one gene and/or at one locus; identifying at least one haplotype of at least one gene and/or at least one locus; or identifying at least one polymorphism unique to at least one haplotype of at least one gene and/or at least one locus. Genotypic variations may also include inserted transgenes or other changes engineered in the host genome.

A “doubled haploid plant” is a plant that is developed by the doubling of a haploid set of chromosomes. A doubled haploid plant is homozygous.

As used herein, the phrase “elite line” refers to any line that is substantially homozygous and has resulted from breeding and selection for superior agronomic performance.

As used herein, the term “gene” refers to a hereditary unit including a sequence of DNA that occupies a specific location on a chromosome and that contains genetic instructions for a particular characteristic or trait in an organism.

As used herein, the phrase “genetic gain” refers to an amount of an increase in performance that is achieved through artificial genetic improvement programs. The term “genetic gain” can refer to an increase in performance that is achieved after one generation has passed.

As used herein, the phrase “genetic map” refers to an ordered listing of loci usually related to the relative positions of the loci on a particular chromosome.

As used herein, the phrase “genetic marker” refers to a nucleic acid sequence (e.g., a polymorphic nucleic acid sequence) that has been identified as being associated with a trait, locus, and/or allele of interest and that is indicative of and/or that can be employed to ascertain the presence or absence of the trait, locus, and/or allele of interest in a cell or organism. Examples of genetic markers include, but are not limited to genes, DNA or RNA-derived sequences (e.g., chromosomal subsequences that are specific for particular sites on a given chromosome), promoters, any untranslated regions of a gene, microRNAs, short inhibitory RNAs (siRNAs; also called small inhibitory RNAs), quantitative trait loci (QTLs), transgenes, mRNAs, double-stranded RNAs, transcriptional profiles, and methylation patterns.

As used herein, the term “genotype” refers to the genetic makeup of an organism. Expression of a genotype can give rise to an organism's phenotype (i.e., an organism's observable traits). A subject's genotype, when compared to a reference genotype or the genotype of one or more other subjects, can provide valuable information related to current or predictive phenotypes. The term “genotype” thus refers to the genetic component of a phenotype of interest, a plurality of phenotypes of interest, and/or an entire cell or organism.

As used herein, “haplotype” refers to the collective characteristic or characteristics of a number of closely linked loci within a particular gene or group of genes, which can be inherited as a unit. For example, in some embodiments, a haplotype can comprise a group of closely related polymorphisms (e.g., single nucleotide polymorphisms; SNPs). A haplotype can also be a characterization of a plurality of loci on a single chromosome (or a region thereof) of a pair of homologous chromosomes, wherein the characterization is indicative of what loci and/or alleles are present on the single chromosome (or the region thereof).

As used herein, the term “heterozygous” refers to a genetic condition that exists in a cell or an organism when different alleles reside at corresponding loci on homologous chromosomes.

As used herein, the term “homozygous” refers to a genetic condition existing when identical alleles reside at corresponding loci on homologous chromosomes. It is noted that both of these terms can refer to single nucleotide positions, multiple nucleotide positions (whether contiguous or not), and/or entire loci on homologous chromosomes.

As used herein, the term “hybrid”, when used in the context of a plant, refers to a seed and the plant the seed develops into that results from crossing at least two genetically different plant parents.

As used herein, the term “inbred” refers to a substantially or completely homozygous individual or line. It is noted that the term can refer to individuals or lines that are substantially or completely homozygous throughout their entire genomes or that are substantially or completely homozygous with respect to subsequences of their genomes that are of particular interest.

As used herein, the term “introgress”, and grammatical variants thereof (including, but not limited to “introgression”, “introgressed”, and “introgressing”), refer to both natural and artificial processes whereby one or more genomic regions of one individual are moved into the genome of another individual to create germplasm that has a new combination of genetic loci, haplotypes, and/or alleles. Methods for introgressing a trait of interest can include, but are not limited to, breeding an individual that has the trait of interest to an individual that does not and backcrossing an individual that has the trait of interest to a recurrent parent.

As used herein, “linkage disequilibrium” (LD) refers to a derived statistical measure of the strength of the association or co-occurrence of two distinct genetic markers. Various statistical methods can be used to summarize LD between two markers but in practice only two, termed D′ and r², are widely used (see e.g., Devlin & Risch 1995; Jorde, 2000). As such, the phrase “linkage disequilibrium” refers to a change from the expected relative frequency of gamete types in a population of many individuals in a single generation such that two or more loci act as genetically linked loci.

As used herein, the phrase “linkage group” refers to all of the genes or genetic traits that are located on the same chromosome. Within a linkage group, those loci that are sufficiently close together physically can exhibit linkage in genetic crosses. Since the probability of a crossover occurring between two loci increases with the physical distance between the two loci on a chromosome, loci for which the locations are far removed from each other within a linkage group might not exhibit any detectable linkage in direct genetic tests. The term “linkage group” is mostly used to refer to genetic loci that exhibit linked behavior in genetic systems where chromosomal assignments have not yet been made. Thus, in the present context, the term “linkage group” is synonymous with the physical entity of a chromosome, although one of ordinary skill in the art will understand that a linkage group can also be defined as corresponding to a region (i.e., less than the entirety) of a given chromosome.

As used herein, the term “locus” refers to a position on a chromosome of a species, and can encompass a single nucleotide, several nucleotides, or more than several nucleotides in a particular genomic region.

As used herein, the terms “marker” and “molecular marker” are used interchangeably to refer to an identifiable position on a chromosome the inheritance of which can be monitored and/or a reagent that is used in methods for visualizing differences in nucleic acid sequences present at such identifiable positions on chromosomes. A marker can comprise a known or detectable nucleic acid sequence. Examples of markers include, but are not limited to genetic markers, protein composition, peptide levels, protein levels, oil composition, oil levels, carbohydrate composition, carbohydrate levels, fatty acid composition, fatty acid levels, amino acid composition, amino acid levels, biopolymers, starch composition, starch levels, fermentable starch, fermentation yield, fermentation efficiency, energy yield, secondary compounds, metabolites, morphological characteristics, and agronomic characteristics. Molecular markers include, but are not limited to restriction fragment length polymorphisms (RFLPs), random amplified polymorphic DNA (RAPD), amplified fragment length polymorphisms (AFLPs), single strand conformation polymorphism (SSCPs), single nucleotide polymorphisms (SNPs), insertion/deletion mutations (indels), simple sequence repeats (SSRs), microsatellite repeats, sequence-characterized amplified regions (SCARs), cleaved amplified polymorphic sequence (CAPS) markers, and isozyme markers, microarray-based technologies, TAQMAN® markers, ILLUMINA® GOLDENGATE® Assay markers, nucleic acid sequences, or combinations of the markers described herein, which can be employed to define a specific genetic and/or chromosomal location.

A marker may correspond to an amplification product generated by amplifying a nucleic acid with one or more oligonucleotides, for example, by the polymerase chain reaction (PCR). As used herein, the phrase “corresponds to an amplification product” in the context of a marker refers to a marker that has a nucleotide sequence that is the same as or the reverse complement of (allowing for mutations introduced by the amplification reaction itself and/or naturally occurring and/or artificial alleleic differences) an amplification product that is generated by amplifying a nucleic acid with a particular set of oligonucleotides. In some embodiments, the amplifying is by PCR, and the oligonucleotides are PCR primers that are designed to hybridize to opposite strands of a genomic DNA molecule in order to amplify a genomic DNA sequence present between the sequences to which the PCR primers hybridize in the genomic DNA. The amplified fragment that results from one or more rounds of amplification using such an arrangement of primers is a double stranded nucleic acid, one strand of which has a nucleotide sequence that comprises, in 5′ to 3′ order, the sequence of one of the primers, the sequence of the genomic DNA located between the primers, and the reverse-complement of the second primer. Typically, the “forward” primer is assigned to be the primer that has the same sequence as a subsequence of the (arbitrarily assigned) “top” strand of a double-stranded nucleic acid to be amplified, such that the “top” strand of the amplified fragment includes a nucleotide sequence that is, in 5′ to 3′ direction, equal to the sequence of the forward primer—the sequence located between the forward and reverse primers of the top strand of the genomic fragment—the reverse-complement of the reverse primer. Accordingly, a marker that “corresponds to” an amplified fragment is a marker that has the same sequence of one of the strands of the amplified fragment.

The term “phenotype” refers to any observable property of an organism, produced by the interaction of the genotype of the organism and the environment. A phenotype can encompass variable expressivity and penetrance of the phenotype. Exemplary phenotypes include but are not limited to a visible phenotype, a physiological phenotype, a susceptibility phenotype, a cellular phenotype, a molecular phenotype, and combinations thereof.

As used herein, the term “plant” refers to an entire plant, its organs (i.e., leaves, stems, roots, flowers etc.), seeds, plant cells, and progeny of the same. The term “plant cell” includes without limitation cells within seeds, suspension cultures, embryos, meristematic regions, callus tissue, leaves, shoots, gametophytes, sporophytes, pollen, and microspores. The phrase “plant part” refers to a part of a plant, including single cells and cell tissues such as plant cells that are intact in plants, cell clumps, and tissue cultures from which plants can be regenerated. Examples of plant parts include, but are not limited to, single cells and tissues from pollen, ovules, leaves, embryos, roots, root tips, anthers, flowers, fruits, stems, shoots, and seeds; as well as scions, rootstocks, protoplasts, calli, and the like.

As used herein, the term “polymorphism” refers to the presence of one or more variations of a nucleic acid sequence at a locus in a population of one or more individuals. The sequence variation can be a base or bases that are different, inserted, or deleted. Polymorphisms can be, for example, single nucleotide polymorphisms (SNPs), simple sequence repeats (SSRs), and Indels, which are insertions and deletions. Additionally, the variation can be in a transcriptional profile or a methylation pattern. The polymorphic sites of a nucleic acid sequence can be determined by comparing the nucleic acid sequences at one or more loci in two or more germplasm entries. As such, in some embodiments the term “polymorphism” refers to the occurrence of two or more genetically determined alternative variant sequences (i.e., alleles) in a population. A polymorphic marker is the locus at which divergence occurs. Exemplary markers have at least two (or in some embodiments more) alleles, each occurring at a frequency of greater than 1%. A polymorphic locus can be as small as one base pair (e.g., a single nucleotide polymorphism; SNP).

As used herein, the term “population” refers to a genetically heterogeneous collection of plants that in some embodiments share a common genetic derivation.

As used herein, the term “progeny” refers to any plant that results from a natural or assisted breeding of one or more plants. For example, progeny plants can be generated by crossing two plants (including, but not limited to crossing two unrelated plants, backcrossing a plant to a parental plant, intercrossing two plants, etc.), but can also be generated by selfing a plant, creating an inbred (e.g., a double haploid), or other techniques that would be known to one of ordinary skill in the art. As such, a “progeny plant” can be any plant resulting as progeny from a vegetative or sexual reproduction from one or more parent plants or descendants thereof. For instance, a progeny plant can be obtained by cloning or selfing of a parent plant or by crossing two parental plants and include selfings as well as the F₁ or F₂ or still further generations. An F₁ is a first-generation progeny produced from parents at least one of which is used for the first time as donor of a trait, while progeny of second generation (F₂) or subsequent generations (F₃, F₄, and the like) are in some embodiments specimens produced from selfings (including, but not limited to double haploidization), intercrosses, backcrosses, or other crosses of F₁ individuals, F₂ individuals, and the like. An F₁ can thus be (and in some embodiments, is) a hybrid resulting from a cross between two true breeding parents (i.e., parents that are true-breeding are each homozygous for a trait of interest or an allele thereof, and in some embodiments, are inbred), while an F₂ can be (and in some embodiments, is) a progeny resulting from self-pollination of the F₁ hybrids.

As used herein, the phrase “single nucleotide polymorphism”, or “SNP”, refers to a polymorphism that constitutes a single base pair difference between two nucleotide sequences. As used herein, the term “SNP” also refers to differences between two nucleotide sequences that result from simple alterations of one sequence in view of the other that occurs at a single site in the sequence. For example, the term “SNP” is intended to refer not just to sequences that differ in a single nucleotide as a result of a nucleic acid substitution in one as compared to the other, but is also intended to refer to sequences that differ in 1, 2, 3, or more nucleotides as a result of a deletion of 1, 2, 3, or more nucleotides at a single site in one of the sequences as compared to the other. It would be understood that in the case of two sequences that differ from each other only by virtue of a deletion of 1, 2, 3, or more nucleotides at a single site in one of the sequences as compared to the other, this same scenario can be considered an addition of 1, 2, 3, or more nucleotides at a single site in one of the sequences as compared to the other, depending on which of the two sequences is considered the reference sequence. Single site insertions and/or deletions are thus also considered to be encompassed by the term “SNP”.

As used herein, the terms “trait” and “trait of interest” refer to a phenotype of interest, a gene that contributes to a phenotype of interest, as well as a nucleic acid sequence associated with a gene that contributes to a phenotype of interest. Any trait that would be desirable to screen for or against in subsequent generations can be a trait of interest. Exemplary, non-limiting traits of interest include yield, disease resistance, agronomic traits, abiotic traits, kernel composition (including, but not limited to protein, oil, and/or starch composition), insect resistance, fertility, silage, and morphological traits. In some embodiments, two or more traits of interest are screened for and/or against (either individually or collectively) in progeny individuals.

Various methods can be used to introduce a genetic modification at a genomic locus that encodes and polypeptide into the plant, plant part, plant cell, seed, and/or grain. In certain embodiments the targeted DNA modification is through a genome modification technique selected from the group consisting of a polynucleotide-guided endonuclease, CRISPR-Cas endonucleases, base editing deaminases, zinc finger nuclease, a transcription activator-like effector nuclease (TALEN), engineered site-specific meganuclease, or Argonaute.

In some embodiments, the genome modification may be facilitated through the induction of a double-stranded break (DSB) or single-strand break, in a defined position in the genome near the desired alteration. DSBs can be induced using any DSB-inducing agent available, including, but not limited to, TALENs, meganucleases, zinc finger nucleases, Cas9-gRNA systems (based on bacterial CRISPR-Cas systems), guided cpf1 endonuclease systems, and the like. In some embodiments, the introduction of a DSB can be combined with the introduction of a polynucleotide modification template.

A polynucleotide modification template can be introduced into a cell by any method known in the art, such as, but not limited to, transient introduction methods, transfection, electroporation, microinjection, particle mediated delivery, topical application, whiskers mediated delivery, delivery via cell-penetrating peptides, or mesoporous silica nanoparticle (MSN)-mediated direct delivery.

The polynucleotide modification template can be introduced into a cell as a single stranded polynucleotide molecule, a double stranded polynucleotide molecule, or as part of a circular DNA (vector DNA). The polynucleotide modification template can also be tethered to the guide RNA and/or the Cas endonuclease. Tethered DNAs can allow for co-localizing target and template DNA, useful in genome editing and targeted genome regulation, and can also be useful in targeting post-mitotic cells where function of endogenous HR machinery is expected to be highly diminished (Mali et al. 2013 Nature Methods Vol. 10: 957-963.) The polynucleotide modification template may be present transiently in the cell or it can be introduced via a viral replicon.

A “modified nucleotide” or “edited nucleotide” refers to a nucleotide sequence of interest that comprises at least one alteration when compared to its non-modified nucleotide sequence. Such “alterations” include, for example: (i) replacement of at least one nucleotide, (ii) a deletion of at least one nucleotide, (iii) an insertion of at least one nucleotide, or (iv) any combination of (i)-(iii).

The term “polynucleotide modification template” includes a polynucleotide that comprises at least one nucleotide modification when compared to the nucleotide sequence to be edited. A nucleotide modification can be at least one nucleotide substitution, addition or deletion. Optionally, the polynucleotide modification template can further comprise homologous nucleotide sequences flanking the at least one nucleotide modification, wherein the flanking homologous nucleotide sequences provide sufficient homology to the desired nucleotide sequence to be edited.

The process for editing a genomic sequence combining DSB and modification templates generally comprises: providing to a host cell, a DSB-inducing agent, or a nucleic acid encoding a DSB-inducing agent, that recognizes a target sequence in the chromosomal sequence and is able to induce a DSB in the genomic sequence, and at least one polynucleotide modification template comprising at least one nucleotide alteration when compared to the nucleotide sequence to be edited. The polynucleotide modification template can further comprise nucleotide sequences flanking the at least one nucleotide alteration, in which the flanking sequences are substantially homologous to the chromosomal region flanking the DSB.

The endonuclease can be provided to a cell by any method known in the art, for example, but not limited to, transient introduction methods, transfection, microinjection, and/or topical application or indirectly via recombination constructs. The endonuclease can be provided as a protein or as a guided polynucleotide complex directly to a cell or indirectly via recombination constructs. The endonuclease can be introduced into a cell transiently or can be incorporated into the genome of the host cell using any method known in the art. In the case of a CRISPR-Cas system, uptake of the endonuclease and/or the guided polynucleotide into the cell can be facilitated with a Cell Penetrating Peptide (CPP) as described in WO2016073433 published May 12, 2016.

In addition to modification by a double strand break technology, modification of one or more bases without such double strand break are achieved using base editing technology, see e.g., Gaudelli et al., (2017) Programmable base editing of A*T to G*C in genomic DNA without DNA cleavage. Nature 551(7681):464-471; Komor et al., (2016) Programmable editing of a target base in genomic DNA without double-stranded DNA cleavage, Nature 533(7603):420-4.

These fusions contain dCas9 or Cas9 nickase and a suitable deaminase, and they can convert e.g., cytosine to uracil without inducing double-strand break of the target DNA. Uracil is then converted to thymine through DNA replication or repair. Improved base editors that have targeting flexibility and specificity are used to edit endogenous locus to create target variations and improve grain yield. Similarly, adenine base editors enable adenine to inosine change, which is then converted to guanine through repair or replication. Thus, targeted base changes i.e., C⋅G to T⋅A conversion and A⋅T to G⋅C conversion at one more locations made using appropriate site-specific base editors.

In an embodiment, base editing is a genome editing method that enables direct conversion of one base pair to another at a target genomic locus without requiring double-stranded DNA breaks (DSBs), homology-directed repair (HDR) processes, or external donor DNA templates. In an embodiment, base editors include (i) a catalytically impaired CRISPR-Cas9 mutant that are mutated such that one of their nuclease domains cannot make DSBs; (ii) a single-strand-specific cytidine/adenine deaminase that converts C to U or A to G within an appropriate nucleotide window in the single-stranded DNA bubble created by Cas9; (iii) a uracil glycosylase inhibitor (UGI) that impedes uracil excision and downstream processes that decrease base editing efficiency and product purity; and (iv) nickase activity to cleave the non-edited DNA strand, followed by cellular DNA repair processes to replace the G-containing DNA strand.

As used herein, a “genomic region” is a segment of a chromosome in the genome of a cell that is present on either side of the target site or, alternatively, also comprises a portion of the target site. The genomic region can comprise at least 5-10, 5-15, 5-20, 5-25, 5-30, 5-35, 5-40, 5-45, 5-50, 5-55, 5-60, 5-65, 5-70, 5-75, 5-80, 5-85, 5-90, 5-95, 5-100, 5-200, 5-300, 5-400, 5-500, 5-600, 5-700, 5-800, 5-900, 5-1000, 5-1100, 5-1200, 5-1300, 5-1400, 5-1500, 5-1600, 5-1700, 5-1800, 5-1900, 5-2000, 5-2100, 5-2200, 5-2300, 5-2400, 5-2500, 5-2600, 5-2700, 5-2800. 5-2900, 5-3000, 5-3100 or more bases such that the genomic region has sufficient homology to undergo homologous recombination with the corresponding region of homology.

TAL effector nucleases (TALEN) are a class of sequence-specific nucleases that can be used to make double-strand breaks at specific target sequences in the genome of a plant or other organism. (Miller et al. (2011) Nature Biotechnology 29:143-148).

### EXAMPLES

The present disclosure is further illustrated in the following Examples. It should be understood that these Examples, while indicating embodiments of the invention, are given by way of illustration only. Thus, various modifications to the crop model, the relationships to simulate/model the root growth trait at colder temperatures, methods of analyses, and applying such methods for crop improvement are disclosed.

### Example 1

### Aeroponic-Hydroponic Root Growth Platform

The screening platform uses a dual aeroponic-hyrdoponic root growth platform (RGP) combined with imaging methods to evaluate root system architecture (RSA) and growth responses to root zone temperatures within native, transgenic and genome-edited (i.e., precise, site-directed genome modification) plant material.

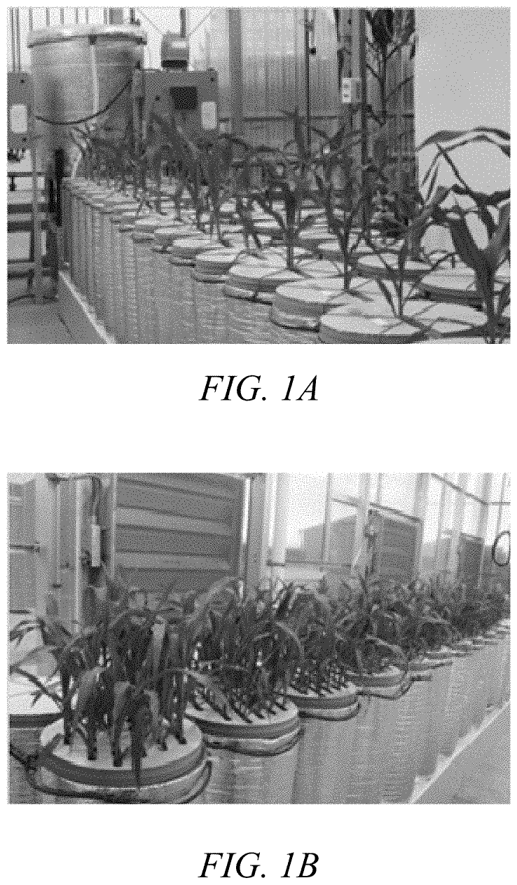

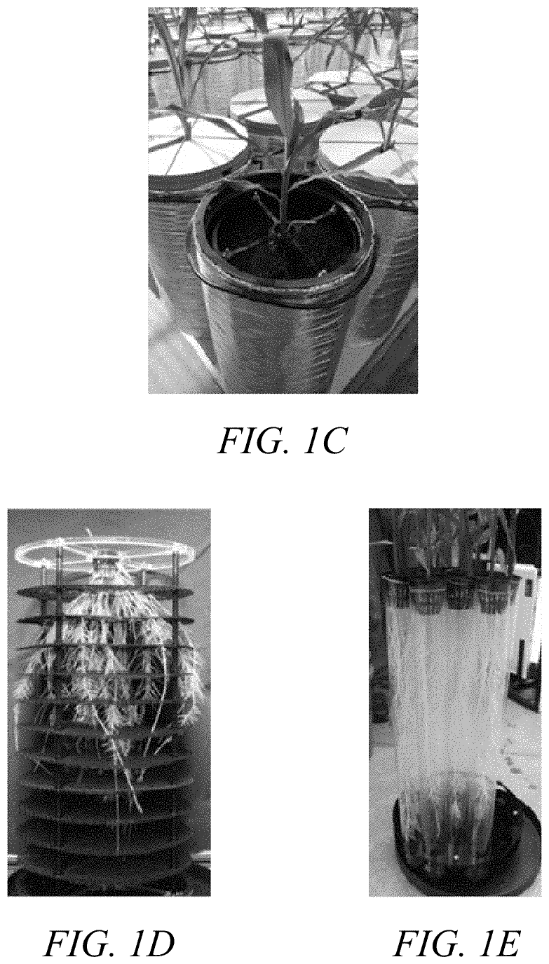

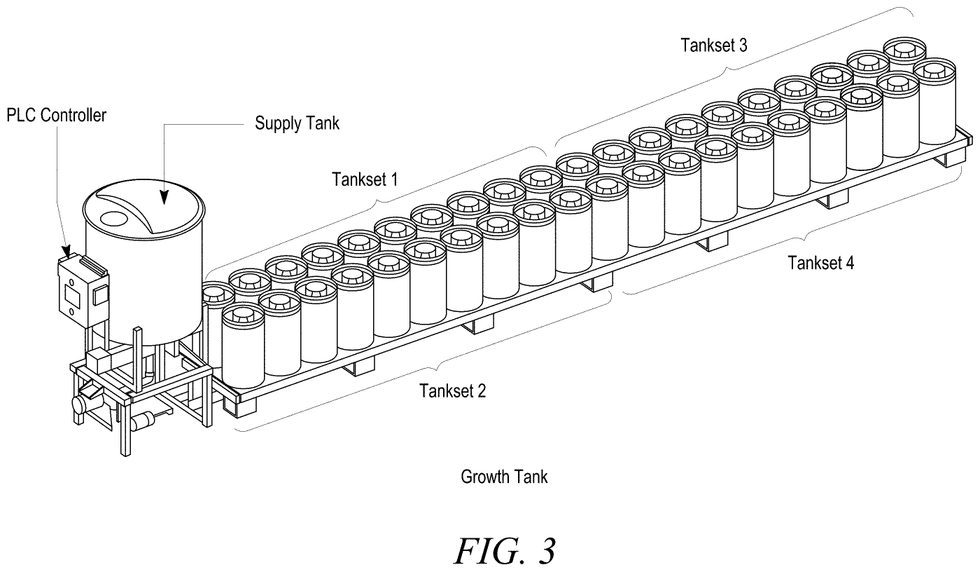

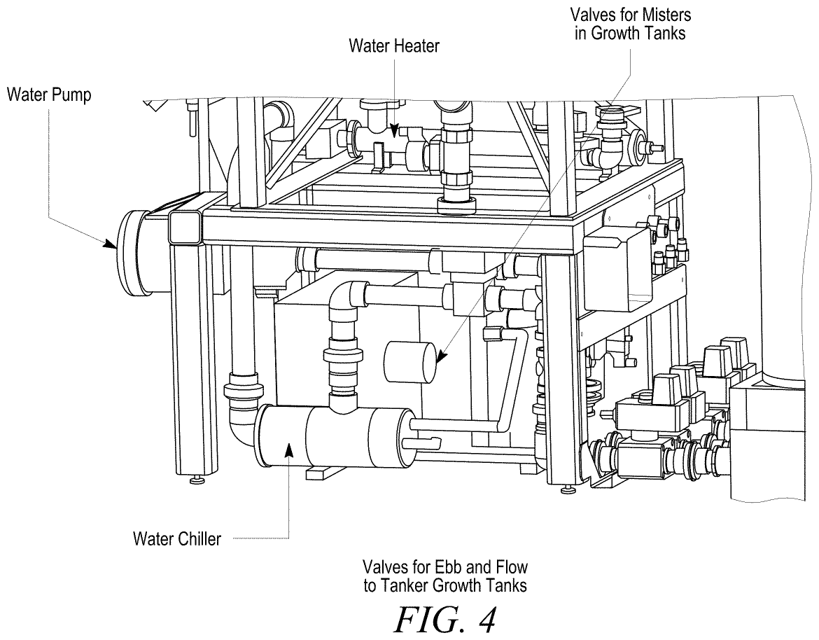

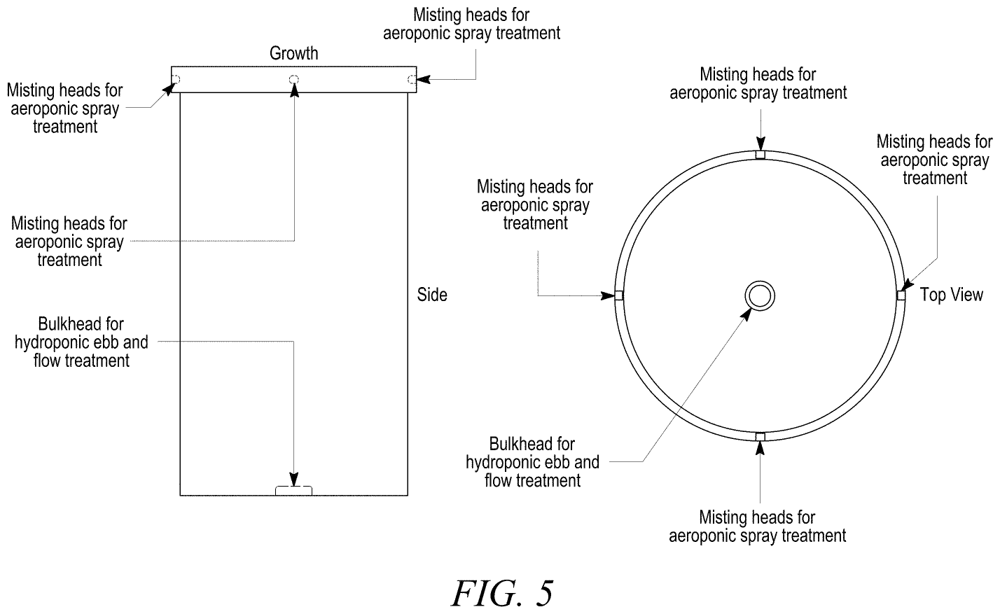

As shown in FIG. 1, in an aspect, the temperature zones are established in insulated growth tanks of the hydroponic RGP by utilizing a combination of aeroponic misting and ebb-and-flow hydroponic functionality where chilled nutrient solution is supplied to the lower root system via ebb and flow and warmed nutrient solution is supplied to the upper root system via misting (FIGS. 1-4). The nutrient solution is contained within a supply tank and is maintained to set temperature using a water chiller. This nutrient solution is pumped to and from the growth tanks on a regular cycle, where the tanks are filled to a desired height from the bottom. When the growth tanks have been filled to the desired height with the chilled solution, a portion of the remaining solution in the supply tank is pumped through a water heater where it is heated to a desired temperature before flowing into the tank through misting heads located at top of the growth tanks, thereby creating a warm upper rooting zone within the growth tanks. Maintaining warmer and cooler rooting zones more closely mimics root temperature gradients found within the rhizosphere under field growth conditions.

In an illustrated embodiment, the dual hydroponic-aeroponic RGP utilizes mesh scaffold supports to preserve root system architecture and to facilitate the high-throughput quantification of root growth and architectural characteristics in 3 or multi-dimensions over time. In an aspect, the imaging system uses specifically engineered methods to capture, reconstruct and measure root traits from plants grown in the root growth platform.

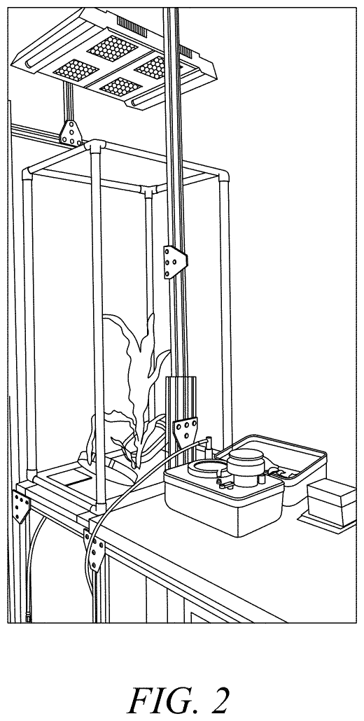

In an aspect, the dual aeroponic-hydroponic growth platform incorporates a scaffolding design to image and analyze corn root system architecture (RSA) between the VE and V6 growth stages and in response to varying root zone temperatures. Corn growth stages can be measured for example, by using the leaf collar method or the “droopy” leaf method, in addition to other available methods. Generally, leaf stages are usually described as “V”—vegetative stages, e.g., V2=two leaves with visible leaf collars. Methods for three-dimensional (3D) imaging of root systems in clear media to capture root growth can be practiced. Additionally, use of mesh scaffolding designs to preserve root system architecture of crop plants grown in soil, soil-like and hydroponic growth systems are provided. In an aspect, the incorporation and use of an aeroponic misting and ebb-and-flow hydroponic functionality with a programmable logic controller (PLC) controlled chilling and heating capability allows two zones (including gradient temperature profiles or ranges that develop within the two or more zones) of temperature treatment to be implemented within the root tanks that more closely represents root zone temperature gradient profiles found in agricultural field systems, e.g., various soils in crop growing conditions. In an aspect (FIG. 1A-E, FIG. 2), the insulation around and on top of root tanks allows the temperature of the root system to be controlled independently of the prevailing environmental conditions (light, humidity, and temperature) experienced by the shoot, for example in a greenhouse, growth chamber, or other controlled environment or even outdoors.

In an aspect, a multiplex arrangement within the growth platform facilitates the evaluation of a large number of plants for a variety of applications such as broad germplasm screens, large scale assays to analyze genomic diversity, or analyzing hundreds of genome editing variants. In an aspect, the multiplex arrangement includes a removable rack that is nested inside each root tank of the growth platform. In an aspect, an experimental rack contains up to 22 clear plastic tubes that hold individual plants, allowing the root systems to be imaged separately or in groups over time and root growth rates of the total root system as well as individual roots to be captured and measured. Higher number of plants can be assembled and analyzed based on the guidance provided herein for scale-up of the RGP.

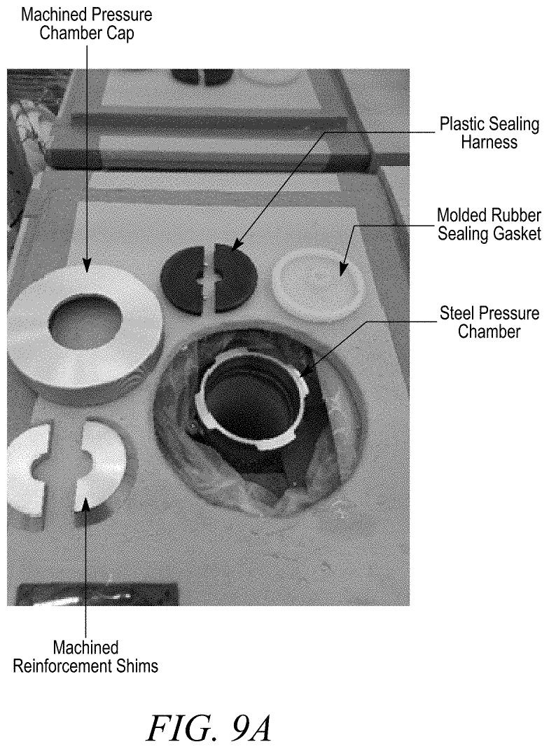

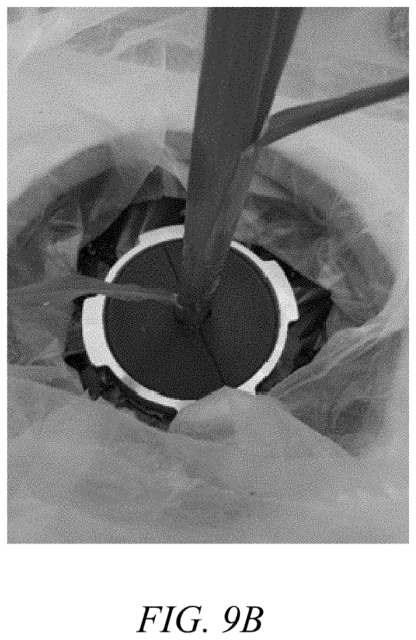

To complement the capture of root growth and root system architecture (RSA) responses of to root zone temperature, a root pressure chamber system with temperature control was developed to capture the impact of root zone temperature on water conductance through the root system and whole plant. The chamber system has a seal to enable screening of whole corn plants with stalks up to 22 mm diameter. Suitable chamber systems can be designed to accommodate larger stalk diameter of corn plants. Root water conductance in addition to root growth and architecture responses is modulated by rooting temperature and impacts the overall water and capture potential of growing crops. To this end, a temperature-controlled root pressure chamber (RPC) was constructed to evaluate root water conductance potential in germplasm grown under a various of root zone temperatures (see e.g., FIG. 9A-9B). Coupling the RPC with a sealed growth chamber for the shoot, root conductance is indirectly measured through the H₂O and CO₂ gas exchange from the shoot and leaves of the plant. In addition to gas exchange methods, root conductance potential can be assessed directly by measuring xylem sap flow through the stalk of the plants.

The principles of RGP and RPC may be multiplied, multiplexed, automated and applied to higher throughput applications through several methods not exclusive to systems and methods previously described. To automate and scale approach the plants may be moved within or separated from their insulated growth containers and individual tubes to temperature-controlled application stations that contain hydroponic and aeroponic temperature control applicators utilizing robotics or conveyer systems. This automated system also move the plants imagers, e.g., digital photography images, to non-destructively capture the growth of the root systems, plants and biological symbionts over time.

### Example 2

### Evaluation of Germplasm Diversity for Root Growth Response to Varying Temperatures

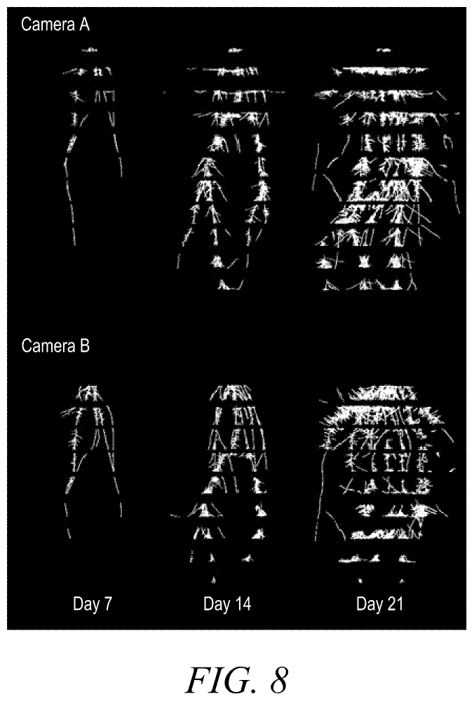

In an aspect, the described root growth platform in Example 1, allows for native germplasm diversity in corn as well as other crop species to be evaluated in a high-throughput manner. To evaluate the diversity within corn, an inbred panel that includes about 251 inbred lines was screened under three different root temperature growing regimes of 10° C., 18° C., and 25° C. (degree Celsius). The 251 inbred lines were selected in an attempt to capture the genetic diversity within several breeding populations as well as public sources. The multiplex tube array within the platform was utilized for these screens and daily root growth rate of the primary root as well as the total root system was measured. A digital imaging system was developed to capture images of the root systems in the tubes over time. These images are then processed with computer algorithms to segment the root systems from the background of the image (FIG. 8). With the segmented root systems, both the total root system volume and total root system and primary root lengths are measured with fully automated algorithms or computed aided software to obtain daily growth rates under the growth regimes.

### Example 3

### Constructing Root System Modeling Based on Crop Response to Varying Root Temperatures

In an aspect, the Root System Modeling (RSM) includes for example, (i) determining equations where root growth is a function of root temperature at the root tip, root type and root age to model root growth response to temperature and implement a root system developmental model to combine with a Crop Growth Model (CGM); (ii) determining germplasm specific root growth response to temperatures and morphology and development parameter distributions, e.g., using an RGP described in Examples 1 and 2; (iii) obtaining inputs from a CGM, e.g., soil temperature and a combination of one or more parameters such as, water, soil impedance, ions such Al³⁺, Phosphorus (P), pH gradients in soil by depth, using weather inputs (temperature, solar radiation and precipitation) to model leaf count, leaf appearance rate, node appearance rate, developmental stage (e.g., growth stages) and thermal time; and (iii) providing outputs to CGM—e.g., root density and occupancy X root type X depth (described generally as root density and occupancy by root type by depth); a non-exhaustive list of outputs including root depth, effective soil depth, occupancy total, occupancy total by layer, length density, potential for water uptake, potential for nutrient uptake, and nutrient/water uptake potential as a function of temperature.

### Example 4

### Root Front Modeling in Conjunction With Crop Growth Model

In an aspect, the Root Front Modeling (RFM) describes the maximum depth at which the root system has grown and can extract water and nutrients as function of time. RFM is constructed or modeled based on (i) determining equations to model root growth response to temperature and implemented in a specialized computer system that runs CGM software; (ii) determining germplasm specific root growth response to temperature parameters—e.g., using an RGP described in Examples 1 and 2; (iii) obtaining certain input parameters from CGM—e.g., soil temperature at root front; and (iv) providing output parameters from the RFM to CGM, e.g., root front depth.

The root front is the maximum depth to which the root system has grown within the soil profile. This depth is the Root Front Depth (RFD) and represents the accumulated daily downward growth of the root system up to the given day after planting (DAP). The root system can directly extract water and nutrient from areas in soil profile at and above the RFD. The root front model (RFM) models the daily root front growth (RFG) and outputs the current RFD in the soil profile.

Daily Root front growth is modeled as:

RFGᵢ=f(ST_{RFD}_{ᵢ}, DSᵢ) where ST_{RF}_{ᵢ} is the soil temperature at the root front on given DAP, i and DSᵢ is the developmental stage of the crop on DAP, i

where

RFGᵢ=0 when DSᵢ is after flowering (for corn)

Root Front Depth on a given DAP is:

$$\text{?} = \text{?}$$

$$\text{?} \text{indicates text missing or illegible when filed}$$

Field Attributes including location, planting density, soil properties, area/volume of interest, plant(s) are obtained. Plant Attributes including ID, location, variety, root system parameters—N(μ,σ), vigor—N(μ,σ), leaf number, thermal time, plant developmental stage and root system are obtained for the Root System Model (RSM) building/calculations. The RSM thus includes at least two main attributes—Field and Plants.

Root System Attributes include root nodes—position, number of roots—N(μ,σ); soil/environment response functions/parameters—N(μ,σ); nodal roots and roots.

### Example 5

### Improved Crop Growth Model with Inputs from Root System Modeling and Root Front Modeling

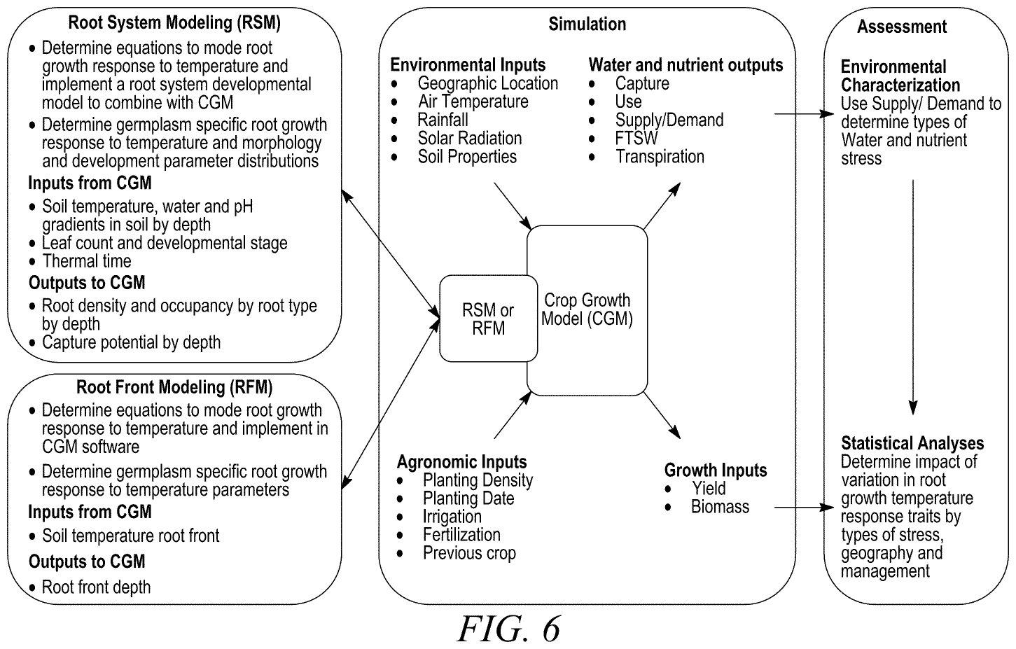

In an aspect, the Crop Growth Model (CGM) is improved or enhanced based on several parameters provided by RSM and/or RFM. An illustration is provided in FIG. 6. For example, a standard CGM includes input parameters such as (i) environmental inputs—e.g., geographic location, air temperature, rainfall, solar radiation, and soil properties; (ii) agricultural inputs—e.g., constructed or modeled based on planting density, planting date, irrigation, fertilization and previous crop. In an aspect, a CGM includes output parameters such as (i) water and nutrient outputs—capture, use, supply/demand, fraction of transpirable soil water (FTSVV), and transpiration; and growth output—yield, grain yield, leaf area and biomass. Many parameters such as the inputs are simulated in the crop growth model to provide predicted output parameters such as yield. In an aspect, genetic/genomic prediction using genetic or genomic information in the form of markers or any other genetic correlation is used to inform CGM to predict root growth, development and function in response to temperature.

Applications of the CGM that incorporate inputs from RSM and/or RFM include for example—selection of parental inbreds or varieties for breeding, hybrids for production, positioning and placement, pre- and in-season management such as planting dates, plant population, and irrigation/fertilization (rooting depth can determine water/nutrient requirements).

### Example 6

### Evaluation of Response of Biological Agents to Temperature with RGP

In an aspect, the described root growth platform in Example 1, allows root zone temperature to be maintained within soil-like and soil substrate filled containers with crop germplasm applied with or exposed to a biological agent, e.g., a biological symbiont or multiple symbionts. To this end, responses of the biological symbionts can be evaluated in response to temperature. One application is the evaluation of nodulation response to temperature in soybean germplasm. Nodulation can be quantified by directly measuring and counting the prevalence of nodulation or by evaluating the growth and capture of nutrients by the host plants.

This Example demonstrates that by modeling root growth and nutrient uptake at various temperatures that are experienced by a developing plant, effect of applied biologicals (e.g., as a seed treatment or soil applied) on root growth, rhizosphere colonization and impact on plant growth and yield can be better assessed. This results in identifying more beneficial biological agents that are better suited to assist developing roots in various temperature zones in the soil.

### Example 7

### Evaluation with Applied Chemical and/or Biological Agents to Temperature to Improve Beneficial Interaction with Crops

In an aspect, the described root growth platform in Example 1, allows root zone temperature to be maintained with tubes with soilless, soil-like, or soil substrate filled containers with crop germplasm inoculated with a biological symbiont or multiple biological agents and/or with applied chemical agents. Impact of temperature on effectiveness of the symbionts and applied chemistry can be measured through quantification of the establishment of symbiont(s) and growth responses and capture of nutrients by the treated host plants.

This Example demonstrates that by modeling root growth and nutrient uptake at various temperatures that are experienced by a developing plant, effect of applied chemical active ingredients (e.g., as a seed treatment or soil applied) on root growth, rhizosphere colonization and impact on plant growth and yield can be better assessed. This results in identifying more beneficial agricultural agents that are better suited to assist developing roots in various temperature zones in the soil.

### Example 8

### Genome-Wide Association Study Findings for Root Growth—Genetic Control for Root Growth Under Low Temperature

One of the purpose of this Example is to identify genetic loci associated with natural variation in root growth within and across temperatures, and identify the candidate genes that contribute to one or more of these signals. To further examine genetic variation root growth at low to cold temperatures, genome wide association studies (GWAS) were performed over stiff stalk and non-stiff stalk inbred lines using primary root and total root system growth data collected. In an aspect, about 251 diverse maize inbreds, 8642 production markers were used after quality control. Three traits of interest: daily growth rate of the total root system (length and area), and daily growth rate of the primary root (length) were measured. The analysis was conducted within each of three temperature treatments: 10° C., 18° C., and 25° C. The analysis was conducted within heterotic groups due to extensive population structure; i.e., the 102 non-stiff stalk (NSS) inbreds and 122 stiff-stalk inbreds were examined in separate GWAS runs.

Commercially available software was used to extract production markers; BT-SAT to run GWAS; Launch to retrieve marker physical positions; proprietary and MaizeGDB genome browsers were used to examine candidate genes in the search space (within +/−1 marker of the marker showing signal in GWAS).

In an aspect, the candidate gene hits are not significant using standard GWAS significance thresholds (e.g., as determined by False Discovery Rate or Bonferroni). When these multiple testing corrections were not applied, the large number of hypothesis tests being conducted (one per marker) would tend to result in a large number of false positives. Thus, it would not be appropriate to use the raw, uncorrected P-values outputted directly by BT-SAT. A few reasonable next steps within the realm of GWAS, one of which has already been conducted, are detailed herein. However, the results herein give a preliminary indication of the nature and localization of genetic signals, with the acknowledgement that these signals are sub-threshold. Signals having a −log 10(P-value) greater than 2 (equivalent to a raw P-value<0.01) are reported below. In case useful as a reference, the most stringent, Bonferroni correction would correspond to a −log 10(P-value) of approximately 5.2, after applying marker QC filters within a heterotic group. The three highlighted (bold) markers had a particularly relevant candidate gene; two of these markers also had the P-values closest to meeting the standard significance thresholds. A marker for which a gene candidate does not appear in the text below did not have a gene with potential (or evident) biological relevance to the traits of interest in its respective search space, as per current annotations.

TABLE 1
Total root system

| | | | | | | | | |
|---|---|---|---|---|---|---|---|---|
| | | | | | | | | Interval |
| M. ID | Temperatures | Het. group | Marker | Chr:pos. | −log10(p) | Effect | r² | (cM) |

Area growth, mm²/day

| | | | | | | | | |
|---|---|---|---|---|---|---|---|---|
| 1 | 10 | NSS | C002PK7-001 | 9:5.0 | 4.1 | 36.01 | 0.18 | 5.0-5.3 |
| 2 | 18 | Stiff stalk | MZA10765-46 | 1:204.8 | 2.6 | −27.89 | 0.12 | 204.7-204.8 |
| 3 | 18 | NSS | C001MDD-001 | 3:159.4 | 2.1 | −61.44 | 0.10 | 159.4-159.4 |
| 4 | 25 | Stiff stalk | MZA10918-19 | 9:47.1 | 2.3 | −40.49 | 0.07 | 47.0-47.2 |

Length growth, mm/day

| | | | | | | | | |
|---|---|---|---|---|---|---|---|---|
| 5 | 10, 25 | Stiff stalk | C002Y3W-001 | 1:246.2 | 2.2 | −17.21 | 0.07 | 246.0-246.3 |
| 6 | 10, 18, 25 | NSS | C0021E8-001 | 7:102.3 | 3.1 | 11 to 18 | 0.14 | 102.0-102.8 |
| 7 | 18 | Stiff stalk | MZA8982-3 | 1:136.5 | 2.1 | −19.24 | 0.06 | 136.4-136.5 |
| 8 | 10, 18, 25 | Stiff stalk | C001X49-001 | 8:129.6 | 2.0 | −9.76 | 0.07 | 129.4-129.7 |
| 9 | 10, 18, 25 | Stiff stalk | C00233H-001 | 9:52.1 | 2.3 | 18.75 | 0.10 | 52.0-52.2 |
| 10 | 25 | Stiff stalk | MZA10373-7 | 5:5.5 | 2.3 | −12.37 | 0.08 | 5.3-5.7 |

TABLE 2
Primary root

| | | | | | | | | |
|---|---|---|---|---|---|---|---|---|
| | | | | | | | | Interval |
| M. ID | Temperatures | Het. group | Marker | Chr:pos. | −log10(p) | Effect | r² | (cM) |

Length growth, mm/day

| | | | | | | | | |
|---|---|---|---|---|---|---|---|---|
| 11 | 10 | Stiff stalk | C001PGV-001 | 5:92.0 | 2.1 | −0.49 | 0.07 | 92.0-92.3 |
| 12 | 10 | Stiff stalk | C002GW1-001 | 10:124.1 | 2.4 | 1.12 | 0.06 | 124.1-125.0 |
| 13 | 10 | NSS | C001860-001 | 1:136.7 | 2.0 | −0.67 | 0.09 | 136.7-136.8 |
| 14 | 18 | Stiff stalk | MZA5336-25 | 1:135.9 | 3.4 | −1.84 | 0.14 | 135.8-135.9 |
| 15 | 18 | NSS | MZA4564-49 | 2:142.1 | 2.2 | −1.59 | 0.09 | 142.0-142.1 |
| 16 | 25 | Stiff stalk | MZA12969-14 | 3:224.4 | 2.3 | 1.50 | 0.07 | 224.2-225.0 |
| 17 | 25 | Stiff stalk | MZA11327-13 | 9:44.9 | 2.0 | −1.57 | 0.06 | 44.5-45.0 |
| 18 | 25 | NSS | MZA15127-20 | 2:207.1 | 2.3 | 2.11 | 0.10 | 207.0-207.1 |

These results indicate that there is genetic variation for these traits, which can be mapped to genetic signals. Daily growth rates of the primary root length, total root system length, and total root system area appear to be regulated by largely distinct sets of genetic loci. Three of the loci showing signal for total root system length were identified in all three temperature treatments, indicating that a partially conserved mechanism of genetic control may be in place across the analyzed temperatures. Gene candidates of particular interest, for further evaluation internal maize mutant collections, would be TORTIFOLIA1-like (Marker 1) and Elongation defective 1 (Marker 14).

Next steps in terms of statistical criteria: (1) an additional model run across all heterotic groups (i.e. the entire panel) rather than within each heterotic group, in case the increased sample size and some amount of shared signal across het. groups, after having corrected for the substantial population structure between them may provide increased power. (2) A pathway-level analysis can be conducted in which only markers in the vicinity of genes with known involvement in root growth and/or cold stress response are tested, so that fewer hypothesis tests are being carried out (making for a less stringent correction).

Independent of root system vigor, root systems responsiveness was shown to vary within hybrids and this variation appears to influence overall rooting depth and length density resulting in an improvement of yields across large regions of the US. The GWAS studies in inbred lines revealed that genetic loci can act at independent temperatures suggesting that these changes can be genetically selected for and optimized within regions of the growth response curve. Root sap flow and conductance show that there is genetic element to root conductance responses decreasing temperature and that can be further optimized. If there is limited potential to leverage natural variation and conventional breeding approaches to shift the minimum base temperature of root growth in maize, other methods such as genome editing or transgenic biotech approaches are undertaken to capture inter-species variation, increase the potential for management and cropping system designs that maximize total exploration of the soil profile within agricultural systems.

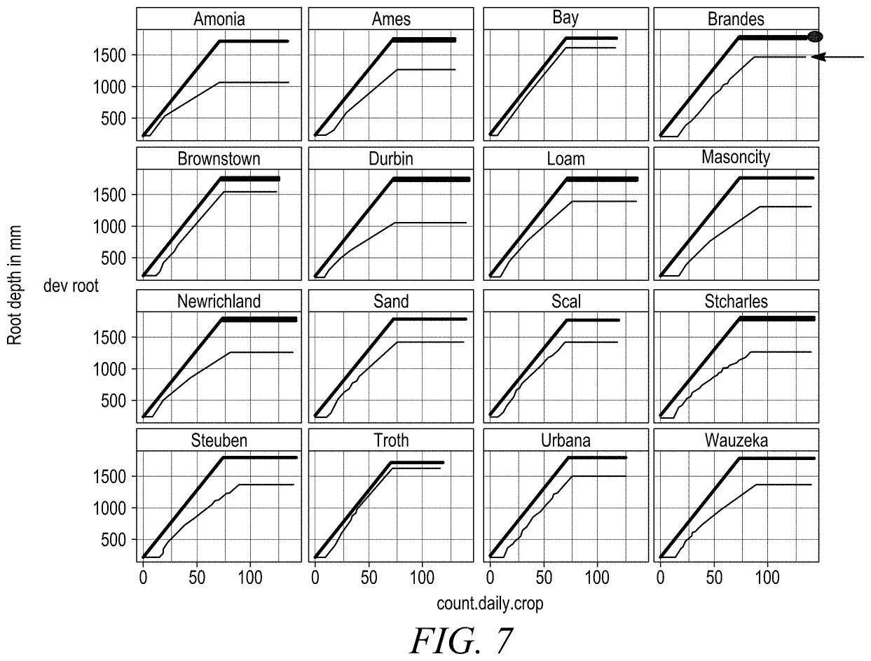

One of the findings from the root simulation studies is that moderate yield environments are also where root traits and their responses to colder soil temperatures showed the greatest individual impact, explaining up to 25% of the overall yield variation when analyzed together with shoot traits from modern commercial and precommercial hybrids (see e.g., FIG. 7). This result suggests that selection pressure could be applied to cold response root traits independently of shoot traits to improve performance in moderate yield environments. Furthermore, the effects of root responsiveness (tbmid) and base temperature (tbmin) were found to be nearly equal in these environments, highlighting the complementary opportunity of selection for root responsiveness within native germplasm combined with the potential leveraging of biotech approaches to lower the minimum base temperature of root growth.

### Example 9

### Microtubule-Associated Protein TORTIFOLIA1-Like Protein—Gene Candidate

Gene candidate in the search space for Marker 1, associated with growth rate of total root system area at 10° C.: Microtubule-associated protein TORTIFOLIA1-like protein was identified as a candidate for contributing to the genetic variation of root response to temperatures. GAIA entry: annotations (see GO terms, likely electronically inferred) of cortical microtubule, transverse to long axis; microtubule binding; circumnutation [helical growth of organ tip]; multicellular organismal development; unidimensional cell growth. MaizeGDB ID: GRMZM2G377690. Annotations (computational analysis, see GO terms in ‘Ontology’ box) include response to freezing, homoiothermy; expressed in crown roots node 5 in B73. TAIR for Arabidopsis TORTIFOLIA1 (SPIRAL2): Arabidopsis SPR2 and SPR2L are homologs with differing expression across tissues (root tips and root hairs, respectively).

### Example 10

### Cytochrome b561/Ferric Reductase Transmembrane Protein—Gene Candidate

Gene candidate in the search space for Marker 2 was associated with growth rate of total root system area at 18° C.: Cytochrome b561/ferric reductase transmembrane protein. The GAIA entry relates to ascorbate. MaizeGDB ID: GRMZM2G081148, expressed in roots of B73.

### Example 11

### Candidate Genes Associated with Marker IDs 11, 12, 14, and 17 (Table 2)

Multiple candidates for Marker 11 (10° C.) were identified and additional evaluations can narrow to a single gene. (1) Auxin response factor. GAIA, MaizeGDB entries; highly expressed in roots in B73, homolog in Arabidopsis is an indole-3-acetic acid [IAA]-related transcription factor. (2) Squamosa promoter binding protein-like. GAIA entry. A class of TFs generally known to have involvement in plant development, also shows relation to gibberellic acid, which has a role in root elongation; review. (3) A 3-phosphoinositide-dependent protein kinase. (4) Glutathione S-transferase (GST). GAIA entry. Known roles in oxidative stress, which would be a major component of cold stress; this enzyme has been studied in roots of rice, soy, and maize, likely among others.

Multiple candidates for Marker 12 (10° C.) were also identified and may be able to narrow to a single gene through use of existing internal expression data (for roots) and through further checks of homology, depending on the final significance threshold. (1) Malate dehydrogenase. GAIA entry. Shown to be related to lateral root growth in relation to zinc or copper; source. (2) The ‘always early’ gene, mybr71-MYB-related-transcription factor 71. GAIA, MaizeGDB entries. The maize version has homology to disease resistance proteins (DIRPS), which are mentioned to be responsive to abiotic stressors as well (source). Overexpression mutants of MYBR1 (a different MYB-related TF) in Arabidopsis had shorter primary roots, whereas loss-of-function mutants had longer primary roots (source).

Gene candidate in the search space for Marker 14 (18° C.): Elongation defective 1 protein/ELD (KOB1). GAIA entry. Homologous to ABA-insensitive 8; appears to have major relation to root growth in Arabidopsis (see images of mutant phenotypes; source).

Gene candidate in the search space for Marker 17 (25° C.): Two-component response regulator ARR12-like protein. GAIA entry. UniProt: annotations for homolog in Arabidopsis relate to primary root growth, through a cytokinin-related signaling pathway.

### Example 12

### Cytochrome b561/Ferric Reductase Transmembrane Protein—Gene Candidate

Gene candidate in the search space for Marker 2, associated with growth rate of total root system area at 18° C.: Cytochrome b561/ferric reductase transmembrane protein.

### Example 13

### Temperature Gradients and Soil Root Growth Platform

This Example demonstrates that the root front modeling, root growth platform system, to assess root architecture responses using the hydroponic-aeroponic system can be adapted to accommodate temperature controlled soil containers.

For example, various soil types can be chosen to mimic a particular geographic location or environment. Based on the desirable temperature gradients, the root system chamber can be configured to receive one or more subsections such that a temperature gradient can be maintained within those subsections, by appropriate insulation and other temperature controlling adaptations. This can be achieved for example, through the use of one or more soil heat flux plates (using thermopiles to measure passive thermal energy gradients across the plate), thermocouples, soil sensors, probes and other heating/cooling elements or the build-in built-temperature control within hydroponic-aeroponic ebb and flow root growth platform.

In an embodiment, insulated growing containers are made to assess the heat transfer rates after applied different temperature conditions in the soil near the root zone. A control system (without any specific heating-coiling components) that is maintained at constant, representative average root zone temperatures is selected for comparative purposes.

A platinum resistance thermometers (PT) sensors are installed inside the soil near the root zone. Data collection over a period is conducted. Thermocouples are used to measure and control soil temperature variations. Simulating the heat transfer in porous media such as soil can be evaluated and accordingly the amount of heating/cooling needed can be programmed. In an embodiment, even if soil is a discontinuous medium, approximations can be included such that the soil is treated as a continuous medium for modelling purposes. Soil moisture probes, for example reflectomenty probes, used to measure volumetric water content (VWC) of the soil volumetric water content (VWC) of the soil.

Multiple soil thermocouple probes installed within the soil sections measure temperatures at a plurality of locations, or junctions, for example, a type E thermocouple wire. Thermocouple junctions can also be programmed to heat local zones as needed to maintain the desired temperature. In an embodiment, the root growth chamber (including soil) can be maintained at colder temperatures, with the heating elements providing the necessary temperature gradient profiles from the top of the soil layer and progressing colder as the depth increases. The various sections within the root growth chamber can have, for example, a thermal separation layer to maintain the temperature gradients. A mesh scaffold may also be used, optionally to maintain the soil compaction to mimic the field soil setting and preserve root architecture for imaging within the visible and non-visible spectrums. A non-destructive imaging source, such as for example, an x-ray imaging system is used to acquire digital images over an extended period to monitor root growth across the temperature gradients within the soil. Multiple plant lines can be tested within the same chamber by analyzing the root surface architecture associated with each plant. In addition to modeling root growth across the various soil temperature profiles, soil or seed applied treatments such as crop protection agents, biologicals and weed control agents such as herbicidal action can also be measured.

### Example 14

### Low Temperature Effects on Rate and Depth of the Root Front

Root growth slows under low temperature. To further characterize root growth responses to low temperature, a temperature-controlled growth and imaging platform was developed. Root growth studies were performed. Over a range of rooting temperatures, primary root growth (PRG, mm day-1) was measured on hybrid and inbred panels and total root systems length and area growth (TRSG and TRSAG in mm day-1 and mm2 day-1) was additionally measured on the inbred lines. A temperature dependent piecewise sinusoidal growth response curve was fit to the PRG for each line using a non-linear mixed model revealing almost no or minimal variation for the minimum base temperature for root growth (tbmin) in either panel where root growth was found to cease at 5.6 and 8.5° C. for the inbreds and hybrids respectively. The maximum rate of growth (rgrₘₐₓ, representative of root system vigor) varied within and across both panels where rgrₘₐₓ ranged from 20.2 to 58.5 mm day-1 for inbreds and 50.0 to 64.2 mm day-1 for hybrids. To investigate G×E interaction of growth over the entire temperature response range, a piecewise triangular distribution cdf curve was fit to PRG for each hybrid using a non-linear mixed model and the predicted inflection point of the cure was examined. The inflection point (tb_{mid}) was found to range from 18.6 to 19.6° C. across hybrids with little correlation to observed rgrmax. This inflection point will be referred to as root responsiveness where a lower tb_{mid} represents a lower responsiveness to decreasing root zone temperatures or an enhanced ability to grow under cooler soil temperatures. When fitting the same curve to the inbred lines, a tb_{mid} of 18.7° C. was measured, however no variation was detected across these lines possibly due to the limited number treatment temperatures tested along the growth response curve.

### Example 15

### Low Temperature Decreases Root Conductance

Root conductance decreases under low temperature. To further examine hydraulic responses to low temperatures, a temperature-controlled root pressure chamber platform was developed, and root conductance studies were performed (see FIGS. 2, 9A-9B). Light response studies across four light levels (125, 320, 515 or 720 J m-2 s-1) were first run using a maize commercial hybrid, revealing that whole plant transpiration (TR) and photosynthesis (P) reduces when root systems are subjected and acclimated to colder root zone temperatures where the maximum TR and P from nonlinear plateau model reduced from 6.0 to 3.8 mg H2O m-2 s-1 and 3.5 to 1.9 mg CO2 m-2 sec-1 between 18 and 10° C. treatments respectively. The slope of a linear fit between TR and Balance Pressure (BP) reduced from 3.56 to 2.15 mg H2O m-2 s-1 MPa-1 indicating that a decreased leaf water potential is also required to induce water flow under cool root treatment. Root sap flow (RSF) also significant reduced from 7.6 to 3.2 mg H2O s-1 between treatments indicating that whole root system conductance is also reduced.

To examine variability with germplasm, RSF was then measured at set of 12 modern commercial hybrids at a rooting temperature of 14° C. When adjusting for total plant leaf area (TPLA) at the time of measurement, RFS per TPLA was found to range significantly across hybrids from 31.6 to 36.5 mg H2O m-2 s-1 indicating genetic variation for root system conductance. To further examine RSF responses to temperature, 3 of 12 maize hybrids were tested at rooting temperatures 10, 15, 20, 25 and 30° C. revealing that RSF was constant from temperatures 30 to 15° C. and half that 10° C. allowing for a linear plateau function to be fit to conductance with a minimum base temperature of conductance of 5° C. RSF nearly ceased when the root system experienced water waterlogging at the higher treatment temperatures.

### Example 16

### High-Throughput Automated Root Growth Platform

This root growth platform setup, shown in illustrated embodiments such as for example, in FIGS. 1-3 are capable of being operated at high throughput scale, automated, or semi-automated to enable large scale screening and evaluation of temperature effects on root growth and function. For example, a series of multiplexed root growth chambers are linked to controllers and operated under a variety of conditions to mimic a variety of soil, climatic, and other environmental inputs. Mechanized systems, aided by robotics, machine vision, machine learning and other artificial intelligence assisted systems increase the efficiency and through-put of the root growth platform described herein. For example, a plurality of the root growth platform components can be taken out of the chambers for observation using robotics, guided by machine vision. In certain embodiments, the plants growing in the scaffold set-up can move through a conveyor belt for automated image acquisition process.

### Example 17

### Hydroponic Root Growth Platform

Root growth experiments were conducted on a maize (Zea mays) inbred diversity panel and a modern maize hybrid panel consisting 249 lines and 99 hybrids respectively, where plants were evaluated in a temperature-controlled, hydroponic root growth and imaging platform within controlled environment greenhouses. The growth platform comprised of individual modules, each containing an insulated 760 L supply tank, 40 insulated 57 L growth tanks, a centrifugal water pump, a water heater and chiller, a PLC control unit, and component plumbing, wiring, and temperature and flow sensors. The growth tanks were arranged into 4 tank sets of 10 growth tanks each and a modified Magnavaca's nutrient solution was supplied to each tank set on a regular cycle via pump-assisted ebb and flow. The growth modules and tanks contained an integrated misting system that was connected to the supply tank for supplemental temperature control in-between ebb and flow cycles between tank sets. Inside each growth tank was a rack with 22 transparent plastic 56 cm H×3 cm ∅ open-bottom growth tubes with a netpot at top filled with rockwool for growing the plants individually and facilitate temporal imaging of their roots. During the growth experiments, pre-germinated seedlings with primary roots between 3 and 10 cm long were transplanted into the growth tubes and pre-grown with a root zone temperature of 25° C. for 5 days for inbred and 4 days for hybrid experiments. For inbred experiments, the pre-grown plants were imaged immediately prior to being moved into treatment modules that were held at 10, 18 or 25° C., then imaged again after 3 days. For hybrid experiments, the pre-grown plants were subjected to a 3-phase temperature course of either 25:18:10 or 25:14:5° C. Images of the root systems were captured at the beginning and/or end of each phase of the treatment course where phase one, two and three lasted 2, 2 and 3 days respectively. The root system images were captured on a custom imaging system and analyzed. From the captured root systems images, total root system area, total root system length and primary root length (in mm2, mm, and mm) were measured and the sequential measurements for each plant were used to calculate the total root system area growth (TRSAG in mm2 day-1), total root system growth (TRSG in mm day-1) and primary root growth (PRG in mm day-1) rates. Growth rate BLUPS within each temperature (10, 18 and 25° C.) for each inbred were estimated using ASReml-R with mixed-model equation. Individual growth coefficients (tbmin and rgrmax) from a piecewise sinusoidal growth curve were estimated for each inbred and hybrid using the nlme package within R with non-linear mixed model equations in the inbred and hybrid experiments respectively where the temperature of maximum growth (tbmax) was fixed to 30° C. Using the estimated tbmin and rgrmax coefficients, the inflection point (tbmid) from a piecewise triangular cdf curve was then estimated for the hybrids using non-linear mixed model equation.

### Example 18

### Root Function and Conductance Studies

Root function and conductance experiments were performed on maize hybrids using a temperature-controlled root pressure chamber system. The root pressure chamber system consisted of a Model 600-EXP Super Pressure Chamber from PMS Instrument Corporation with additional temperature control and a reengineered sealing orifice to accommodate whole plant stalks up to 22 cm ∅ (FIG. 9A-9B). The root pressure chamber was integrated onto a mobile cart with a transparent film shoot enclosure made with polyethylene terephthalate film with internal and external fans, wiring and pumps, and a CR1000 datalogger and LI-850 CO₂/H₂O gas analyzer from Campbell Scientific and LI-COR Biosciences. All plants were grown in the greenhouse in PVC tubes containing general purpose potting substrate composed of peat moss, vermiculite and Osmocote. Plants were acclimated and tested under well-watered conditions in a walk-in growth chamber set to 29° C., 450 J m-2 s-1 with no added humidity. The lights turned off and temperature was reduced to 23° C. with no added humidity during the night cycle. Prior to testing when the plants had reached a V4-V6 growth stage, the tubes were temporarily sealed at the bottom with plastics bags and moved into a growth chamber containing temperature-controlled water baths where the plants could acclimate to root temperatures of 10, 14 or 18° C. for 2 nights prior to testing. All plants continued under well-watered conditions throughout the acclimation period.

For light response studies, a single commercial hybrid was selected for testing and was grown in 60 cm H×8 cm ∅ mesh-bottom tubes. The plants tested at separate light levels of 125, 320, 515 or 720 J m-2 s-1 with root temperatures of 10 or 18° C. with between 15 and 26 successful replicates per light level and treatment. Once the plants root system was sealed into the temperature-controlled pressure chamber and the shoot is isolated, an automated testing program allowed for whole plant transpiration and photosynthesis to be recorded over a 43-minute period prior to pressurizing the roots to observe the balancing pressure. The program included a 20-minute acclimation period where an external refreshing fan moved outside air into the enclosed shoot chamber preceding 6, 2-minute, observation periods where the refreshing fan was stopped, covered, and the change in H2O and CO2 was recorded. Each 2-minute observation period was separated by a 1-minute refresh period to allow fresh air in.

After recording the balancing pressure, and for the root system conductance only experiments, the shoots of the plants were cut off at 10 cm above the base of the stalk. The cross-sectional area of the stalk at the cut and total leaf area of the plants were measured with digital calipers and a LI-COR LI-3100C area meter. Xylem sap exuding from stalks, now to be termed “root sap”, was collected for 5 minutes while keeping the root systems under 0.5 MPa of pressure. Sap was collected by placing a pre-weighed, conical falcon tube with tissue paper to absorb and contain the root sap. For the root conductance only experiments, the plants were grown in 30 cm H×4 cm ∅, open-drained tubes and 12 commercial hybrids were selected for testing at a root temperature of 14° C. with between 21 and 27 successful replicates per hybrid. A subset of 4 of 12 hybrids were tested at 10, 12 and 14° C. in a prior experiment to determine a colder temperature that was most likely to separate the hybrids.

Additional temperature response studies for root conductance were performed on 4 of the 12 hybrids that showed the greatest difference in the conductance studies at 14° C. For these studies a plurality of replicates per hybrid were measured at various temperature treatments.

### Example 19

### Sub-Soil Herbicide and Radiotracer Application For Germplasm Selection within Field Environments

In an aspect, in-field germplasm diversity screens and germplasm selection for root growth response to cold soil temperature can be achieved by combining herbicide or radiotracer application at variable depth via buried drip tape, timed, slow or electronically triggered release, or direct probe injection with in-field soil temperature sensors at plurality of depths within soil profile. Root front growth can be monitored through the timing of the application(s) combined with observation of the shoot via direct visual scoring or assisted through digital imaging and analysis within the visible and non-visible spectra where in-field temperature sensors are used to determine the timing of application as well as to further interpretation of soil temperature growth responses during germplasm selection. Additional, RSM and RFM in Examples 3, 4 and 5 can be utilized prior to the in-field evaluations to determine most suitable locations and geographies for evaluations, during the evaluation to determine the timing of application, and after the evaluation to further interpretation screening results and select optimal germplasm.

What is claimed is:

1. A dual hydroponic-aeroponic root growth platform (RGP) system to evaluate a root system architecture (RSA), comprising:
a. a three-dimensional scaffold contained within a temperature controlled root growth chamber, wherein the scaffold enables the growth of the roots such that the RSA is facilitated, whereby one or more architectural and growth characteristics of the root are capable of being measured over time; and
b. the controlled chamber comprises a variable hydroponic-aeroponic system to evaluate root and root system functional responses to root zone temperature, wherein temperature controlled nutrient solution is provided both hydroponically and aeroponically to simulate temperature gradient profiles in a field soil system.

2. The system of claim 1, wherein the scaffold comprises a plurality of mesh septa that comprises pores to enable growth of roots in a three-dimensional architecture.

3. The system of claim 1, wherein the RGP maintains a root temperature of about 2.5° C. to about 30° C. in the root pressure chamber comprising the nutrient solution.

4. The system of claim 1, further comprises an image acquisition device to obtain one or more images of the growth of the root within the scaffold over time, thereby quantifying the root growth and/or root development.

5. The system of claim 1, wherein colder nutrient solution is provided hydroponically through the lower (bottom) portion of the chamber and warmer nutrient solution is provided aeroponically through the upper (top) portion of the chamber.

6. A method to increase yield of plants grown under one or more environmental conditions, the method comprises growing a plant in a field condition, wherein the plant has been selected for increased yield potential based on a crop growth model (CGM) that includes one or more parameters of a root growth model (RGM), wherein the root growth model comprises phenotypic or genotypic association data with respect to the growth and/or root development of roots in response to temperature variation.

7. The method of claim 6, wherein the root growth and/or root development is controlled by one or more quantitative trait loci (QTL).

8. The method of claim 6, wherein the RGM comprises marker data that correlate with the performance of plant roots under varying temperatures.

9. The method of claim 6, wherein the plant comprises a native genetic variation, an introduced genetic modification, a transgenic trait, or a combination thereof, that impact root growth in response to temperature.

10. The method of claim 6, wherein the plant is selected by whole genome prediction for improved performance of plants due to improved root growth at cooler soil temperatures compared to control plants.

11. The method of claim 6, wherein the plants are planted early in the field compared to control plants that are not selected for increased yield potential.

12. The method of claim 6, wherein the plants are planted at a planting density that is at least 10% to about 30% higher compared to control plants.

13. The method of claim 6, wherein the plants are drought tolerant.

14. The method of claim 6, wherein the plants are cold tolerant.

15. (canceled)

16. (canceled)

17. (canceled)

18. (canceled)

19. (canceled)

20. (canceled)

21. A method of high-throughput analysis of response of roots of a population of plants to root temperature variation, the method comprising:
a. providing an aeroponic-hyrdoponic root growth platform (RGP) to evaluate a root system architecture (RSA) and growth response to root zone temperatures, wherein the hydroponic-aeroponic platform (i) includes a scaffold to preserve the RSA and (ii) facilitate quantification of root growth and one or more architectural characteristics in a three-dimensional set-up over time;
b. providing a root pressure chamber system to evaluate root and root system functional responses to root zone temperature, wherein the root pressure chamber system includes (i) temperature control (ii) root zone pressure control (iii) a stem and/or stalk sealing mechanism (iv) gas exchange monitoring;
c. growing a population of plants in the RGP, wherein the plants exhibit varied root growth characteristics to root zone temperature variation and wherein the RGP maintains a root temperature of about 2.5° C. to about 30° C.;
d. quantifying the root growth and response to temperatures of the plants growing in the RGP by automated acquisition and processing images to quantitate the root growth and/or root development; and
e. analyzing the response of the roots of the population of plants.

22. The method of claim 21, wherein the population of plants are selected from the group consisting of maize, soybean, cotton, canola, rice, wheat and sorghum.

23. The method of claim 21, wherein the population of plants are screened for (a) native variation, (b) introduced targeted genetic modification, (c) transgenic variation, (d) non-targeted introduced genetic modification or (e) a combination thereof.

24. The method of claim 21, wherein the images are obtained using one or more of the following: an optical digital camera, hyperspectral image acquisition device, an X-ray image acquisition device or an infra-red camera.

25. The method of claim 21, wherein the RGP comprises variations in nutrient availability.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A multiplex hydroponic root growth platform (RGP) system to evaluate a root system architecture (RSA), comprising:
a. a temperature controlled root growth chamber comprising a liquid nutrient media, wherein the liquid media is maintained at a pre-determined temperature;
b. a plurality of individual plants housed within separate divided enclosures such that their roots are capable of growing and maintaining the root system architecture over time; and
c. a plurality of temperature controlled root growth chambers, wherein the temperature of one or more of the individual growth chambers are maintained at a specific pre-determined temperature within 2.5° C. to about 30° C.

41. The system of claim 40, wherein the temperature controlled root growth chamber is insulated and the top of the chamber is sealed and is configured to receive a plurality of plants such that the plants are separably positioned through a plurality of openings.

42. The system of claim 40, wherein the divided enclosures are made up of a material that is suitable for high throughput imaging to measure one or more of the root characteristics at the predetermined temperatures.

43. The system of claim 40, further comprises an image acquisition device to obtain one or more images of the growth of the roots within the enclosures over time, thereby quantifying the root growth and/or root development.

44. The system of claim 40, wherein a colder nutrient solution is provided hydroponically through the lower (bottom) portion of the chamber and warmer nutrient solution is provided aeroponically through the upper (top) portion of the chamber.

45. The system of claim 40, wherein the population of plants are selected from the group consisting of maize, soybean, cotton, canola, rice, wheat and sorghum.
